(19) United States
(12) Patent Application Publication
(10) Pub. No.: US 2007/0205547 A1
(43) Pub. Date: Sep. 6, 2007

(54) Clamping device

(75) Inventor: Robert James Siemann, Naperville, IL (US)

Correspondence Address: Lipsitz & McAllister, LLC, 755 MAIN STREET, MONROE, CT, 06468, US

(73) Assignee: BESSEY Tool GmbH & Co. KG, Bietigheim-Bissingen (DE)

(21) Appl. No.: 11/368,032

(22) Filed: Mar. 3, 2006

(51) Int. Cl. B25B 1/00

(52) U.S. Cl. 269/6

(57) ABSTRACT

Clamping device, with a first support member having a first stand portion for positioning the first support member on a surface and a second support member having a second stand portion for positioning the second support member on a surface. The second stand portion has a first surface facing towards the first stand portion and has a second surface facing away from the first stand portion. The second stand portion comprises foot elements projecting from the first surface and from the second surface.

### BACKGROUND OF THE INVENTION

The present invention relates to a clamping device comprising a first support member and a second support member, a connection member which is fixed to the first support member and the second support member, a first clamping member which is fixed to the first support member and a second clamping member which is moveable on the connection member and on which a force can be exerted via a force exerting device.

Examples for such clamping devices are pipe clamps.

US 2004/0041061 A1 discloses a pipe clamp having feet of such a height that a clamp handle can be rotated by the user without interference from a bench on which the pipe clamp rests.

### SUMMARY OF THE INVENTION

In accordance with an example embodiment of the invention, a clamping device is provided, comprising a first support member having a first stand portion for positioning the first support member on a surface and a second support member having a second stand portion for positioning the second support member on a surface. The second stand portion has a first surface facing towards the first stand portion and has a second surface facing away from the first stand portion. The second stand portion comprises foot elements projecting from the first surface and projecting from the second surface. A connection member is fixed to the first support member and the second support member. A first clamping member and a second clamping member are provided for exerting a clamping force on a workpiece or workpieces between the first clamping member and the second clamping member. The first clamping member is arranged on the first support member, and the second clamping member is moveable on the connection member. A threaded spindle is provided which is guided on the second support member and is connected to the second clamping member, and a handle is fixed to the threaded spindle.

Such a clamping device has support areas via which the second support member can be positioned upright on a surface (like the surface of a workbench) in a simple manner. Tipping over is reduced or can be prevented. An enhanced product stability is provided by the foot elements of the second support member. The second support member is stable with regard to tilting to opposite sides and thereby symmetrically stabilized.

In accordance with a further example embodiment of the invention, a clamping device is provided, comprising a first support member having a first stand portion for positioning the first support member on a surface and a second support member having a second stand portion for positioning the second support member on a surface. The second stand portion is set back with regard to an outer end of the second support member, said outer end facing away from the first support member, and said second stand portion does not project beyond said outer end. A connection member is fixed to the first support member and the second support member. A first clamping member and a second clamping member are provided for exerting a clamping force on a workpiece or workpieces between the first clamping member and the second clamping member. The first clamping member is arranged on the first support member, and the second clamping member is moveable on the connection member. A threaded spindle is provided which is guided on the second support member and is connected to the second clamping member, and a handle is fixed to the threaded spindle.

With such an embodiment of the present invention, it is guaranteed that no part of the second support member extends beyond its outer end. Accordingly, contact between an operator's hand driving the threaded spindle via the handle and the second stand portion can be prevented.

Further, it is made possible that the center of gravity of the second support member can be positioned above the second stand portion.

Further example embodiments of the invention are outlined in the detailed description of the invention.

### BRIEF DESCRIPTION OF DRAWINGS

The present invention will hereinafter be described in conjunction with the appended drawing figures, wherein like reference numerals denote like elements, and:

FIG. 1 is a cross-sectional side view of a first example embodiment of a clamping device in accordance with the present invention;

FIG. 2 is an elevated view on a (second) support member in the direction A of the clamping device of FIG. 1;

FIG. 3 is a cross-sectional view of the support member according to FIG. 2 taken at the line 3-3;

FIG. 4 is an elevated view on a (first) support member of the clamping device according to FIG. 1 in the direction B;

FIG. 5 is an elevated view on a (second) clamping member of the clamping device of FIG. 1 in the direction C; and

FIG. 6 is a cross-sectional side view of a second example embodiment in accordance with the present invention.

### DETAILED DESCRIPTION

The ensuing detailed description provides exemplary embodiments only, and is not intended to limit the scope, applicability, or configuration of the invention. Rather, the ensuing detailed description of the exemplary embodiments will provide those skilled in the art with an enabling description for implementing an embodiment of the invention. It should be understood that various changes may be made in the function and arrangement of elements without departing from the spirit and scope of the invention as set forth in the appended claims.

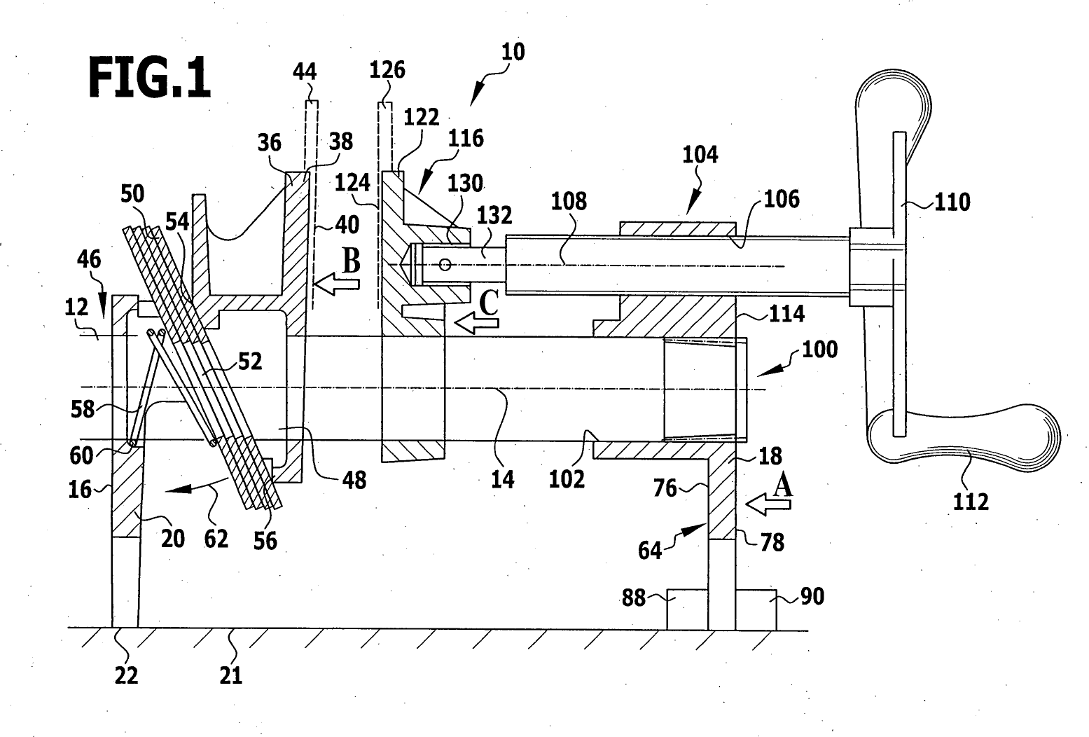

A first example embodiment of a clamping device, which is shown in FIG. 1 and designated there by reference numeral 10, is a pipe clamp having a pipe as a connection member 12 extending along a direction 14. The pipe can have a shape which is substantially cylindrical.

With the connection member 12, in particular, with a pipe as connection member, clamping over a considerable length is possible.

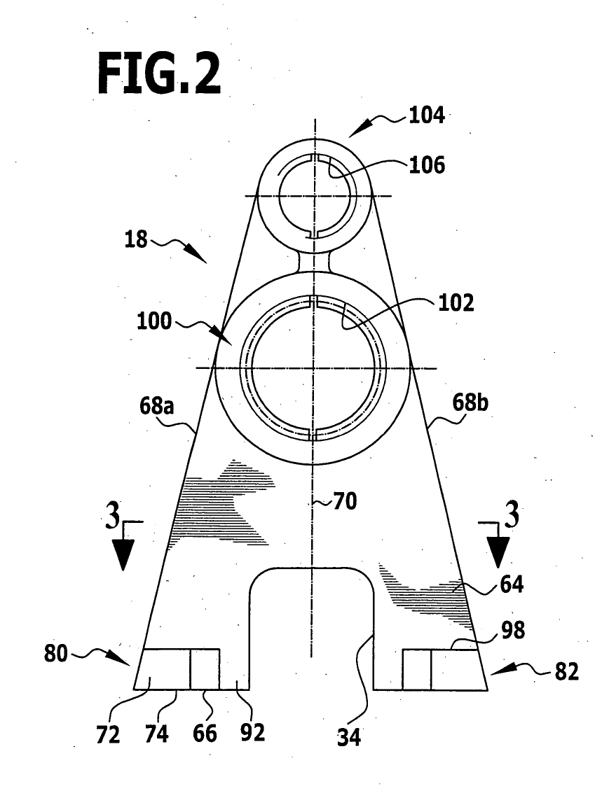

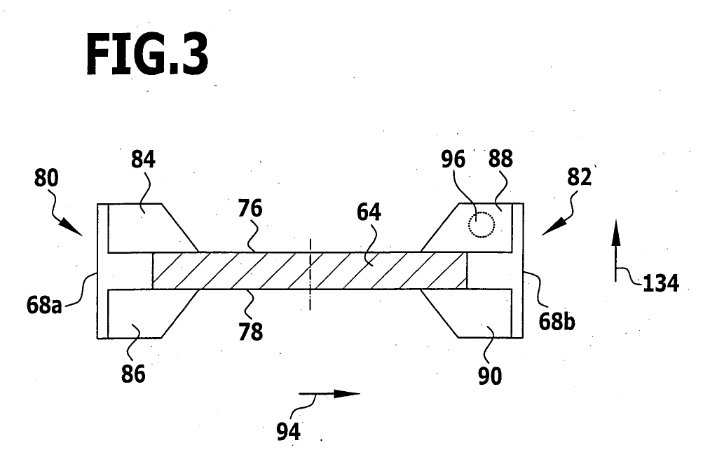

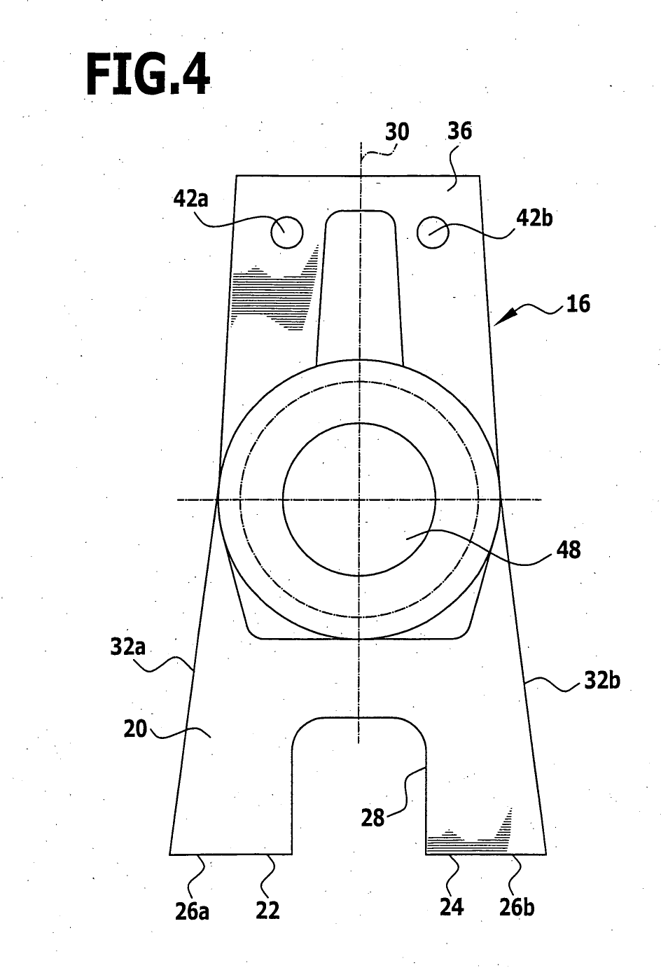

The clamping device 10 comprises a first support member 16 (FIG. 4) and a second support member 18 (FIGS. 2 and 3). Via these support members 16 and 18 the clamping device 10 can be positioned upright standing on a surface 21.

The first support member 16 comprises a first stand portion 20. The first stand portion 20 has a lower stand end 22 with a stand surface 24. The stand surface 24 comprises a first portion 26a and a second portion 26b which are at a distance from each other. The first portion 26a and the second portion 26b are substantially flat. Between the first portion 26a and the second portion 26b a recess 28 in the form of an opening is provided, said recess 28 dividing the stand surface 24 into the first portion 26a and the second portion 26b.

The first support member 16 is substantially symmetrical to a middle line 30. The first stand portion 20 has a first side edge 32a and a second side edge 32b. The first side edge 32a and the second side edge 32b are substantially straight edges. The first side edge 32a is oriented at a small angle with regard to the middle line 30. This angle is in the order of magnitude of 100. The second side edge 32b is oriented with the same angle with regard to the middle line 30 but with opposite orientation. Therefore, the width of the first stand portion 20 in a direction perpendicular to the extension direction 14 of the connection member 12 gets larger towards the lower stand end 22.

The recess 28 has substantially the same dimension as a recess 34 (FIG. 2) of the second support member 18.

The first support member 16 comprises a first clamping member 36 which is rigidly fixed with regard to the first stand portion 20. The first clamping member 36 comprises a clamping area 38 via which a clamping force can be exerted on a workpiece or workpieces. For this, the clamping area 38 has a clamping surface 40 which is substantially flat.

In one example embodiment, the clamping area 38 has through-openings 42a, 42b (FIG. 4) for fixing the first clamping member 36 to a workpiece via screws guided through the through-openings 42a, 42b.

It is possible for a plastic element 44 to be attached to the clamping area 38. The plastic element 44 may be formed as a plastic cap. This plastic element 44 has a contact surface for contacting a workpiece, which contact surface acts to protect the workpiece.

The clamping area 38 and the first stand portion 20 are arranged at a distance from each other. Between the first stand portion 20 and the clamping area 38 a connection device 46 is provided. This connection device 46 has an opening 48 through which the connection member 12 is guided.

The connection device 46 is formed in a such a way that the connection member 12 can be fixed to said connection device 46 with adjustability of the relative position between the connection member 12 and the first support member 16 in the direction 14. Thus, the distance between the first support member 16 and the second support member 18 is adjustable and thereby a clamping width (parallel to the direction 14) is adjustable.

The connection device 46 comprises at least one tilt plate 50. The tilt plate 50 may advantageously be made of a metallic material. The tilt plate 50 comprises an opening 52 for the connection member 12. In the example embodiment shown in FIG. 1, a package of tilt plates 50 comprising, e.g., four tilt plates, is provided. These tilt plates 50 are not rigidly connected to each other.

The connection device 46 has a first contact area 54 and a second contact area 56 for being contacted by the outer tilt plate 50. The first contact area 54 can be contacted by the tilt plate 50 with an area above the opening 52 and the second contact area 56 can be contacted by the tilt plate 50 with an area below the opening 52.

The connection device 46 comprises at least one spring element 58 through which the connection member 12 is guided. The spring element 58 is supported by an area 60 of the connection device 46 which is proximate to the first stand portion 20 or formed by the first stand portion 20. The spring element 58 is formed and arranged in such a way that it exerts a force on the tilt plate 50 or the package of tilt plates 50 and pushes them towards the first contact area 54 and the second contact area 56. Thus, the tilt plate 50 or tilt plates 50 are tilted and act to fix the connection member 12 with regard to the first support member 16.

For allowing a movement of the connection member 12 with regard to the first support member 16, the tilting of the tilt plate or tilt plates 50 must be at least partially lifted. This can be done by moving the tilt plate 50 or tilt plates 50 in a direction 62 away from the contact area 56 as shown in FIG. 1. For this movement, the force of the spring element 58 must be overcome. After such movement of the tilt plate(s) 50, the connection member 12 may be freely guided through the opening or openings 52.

With the connection device 46 the relative position between the connection member 12 and the first support member 16 can be adjusted in a step-free manner. Thus, the distance between the first support member 16 and the second support member 18 can be adjusted in a step-free manner.

The second support member 18 comprises a second stand portion 64 (FIG. 2) in which the recess 34 is formed. In particular, the recess 34 is a through-opening. The recess 34 and the recess 28 have substantially the same dimensions. The second stand portion 64 has a lower stand end 66 for positioning the second support member 18 on the surface 21 and the recess 34 extends to the lower stand end 66.

The second stand portion 64 has a first side edge 68a and a second side edge 68b. These side edges 68a, 68b are substantially straight and are each oriented at a small angle with regard to a middle line 70 of the second support member 18.

The second support member 18 is substantially symmetrical to the middle line 70.

The second stand portion 64 has an increasing width perpendicular to the middle line 70 (and also perpendicular to the connection member 12) towards the lower stand end 66.

In particular, the second stand portion 64 has with regard to its outer dimensions a shape which is similar to the first stand portion 20.

The second stand portion 64 comprises foot elements 72 with stand surfaces 74 for positioning the second support member 18 upright on the surface 21. The second stand portion 64 has a first surface 76 facing towards the first support member 16. The second stand portion 64 has further a second surface 78 facing away from the first stand portion 20. The second stand portion 64 extends between the first surface 76 and the second surface 78.

The foot elements 72 comprise a first pair of foot elements 80 and a second pair of foot elements 82. The first pair of foot elements 80 includes a first foot element 84 projecting from the first surface 76 and a second foot element 86 projecting from the second surface 78. The first foot element 84 and the second element 86 are arranged on opposite sides of the second stand portion 64 and are symmetrical to each other.

The first foot element 84 and the second foot element 86 are formed at the lower stand end 66 at the first side edge 68a or close to the first side edge 68a.

The second pair of foot elements 82 comprises a third foot element 88 projecting from the first surface 86 and comprises a fourth foot element 90 projecting from the second surface 78.

The third foot element 88 and the fourth foot element 90 are formed at the lower stand end 66 at the second side edge 68b or close to the second side edge 68b.

The foot elements 84, 86, 88, 90 are lip-like extensions of the second stand portion 84 projecting out of both sides of the second stand portion 64 and define the stand surface of the second support member 18. The individual stand surfaces of the foot elements 84, 86, 88, 90 are substantially flat. With these lip-like extensions added stability for the second support member 18 is provided.

The first pair of foot elements 80 and the second pair of foot elements 82 are at a distance from each other with regard to a direction between the first side edge 68a and the second side edge 68b. (This direction is perpendicular to the middle line 70 and to the direction 14.) Between the first pair 80 and the second pair 82 the recess 34 is arranged. In particular, the recess 34 is a through-opening. Thus, the second support member 18 has two stand planes at a distance from each other.

The foot elements 84, 86, 88, 90 extend in a direction perpendicular to the middle line 70 but not up to the recess 34 so that a surface area 92 of the respective first surface 76 or second surface 78 is provided between the corresponding foot elements 82, 84, 86, 88 and the recess 34.

The width of the respective foot elements 84, 86, 88, 90 in a direction 94 perpendicular to the direction 14 and to the middle line 70 varies such that this width is larger closer to the respective first surface 76 or second surface 78. Thus, the distance between the first foot element 84 and the third foot element 88 becomes larger away from the first surface 76. The distance between the second foot element 86 and the fourth foot element 90 becomes larger away from the second surface 78.

With such an arrangement, more space is provided for a handle or a user's hand as described below.

The maximum width in the direction 14 of the stand surface of the first pair of foot elements 80 is larger than the maximum width in a transverse direction 94. For example, the maximum width in the direction 14 is twice as large as the width transverse to the direction 14. The same holds for the stand surface of the second pair of foot elements 82.

The recess 34 has a height which is at least twice as large as the height of the foot elements 72. In one example embodiment, the height of the recess 34 is approximately 2.5 times of the height of the foot elements 84, 86, 88, 90 (which have all the same height). In another example embodiment, the recess 34 has a height which is approximately 2.2 times the height of the foot elements 72.

Further, the recess 34 may have width in the direction 94 which is at most approximately 45% of the maximum width of the second stand portion 64. The maximum width of the second stand portion 64 is at its lower stand end 66. In one example embodiment, the recess 34 may have a width which is approximately 36% of the maximum width of the second stand portion 64.

Further, the width of the foot elements 72 in the direction 94 may be at least approximately 20% of the maximum width of the second stand portion 64. In one example embodiment, the width of the foot elements 72 (defined as its maximum width) may be approximately 25% of the maximum width of the second stand portion 64.

The foot elements 72 have an extension width in the direction 14 which is larger than the width of the second stand portion 64 outside the foot elements 72. This width of the second stand portion 64 is defined as the distance between the first surface 76 and the second surface 78. In a particular embodiment, the extension width of the foot elements 72 is 1.25 times the distance between the first surface 76 and the second surface 78.

It is possible that at least one of the foot elements 72 has at least one through-opening 96, for example in the form of a bore, which extends from an upper surface 98 of the corresponding foot element towards its stand surface 74. Via such a through-opening 96, the second stand portion 74 and thereby the second support member 18 can be fixed to the surface 21 by a screw or screws.

The second support member 18 comprises a connection device 100 with an opening 102. The connection member 12 can be positioned in the opening 102 and fixed with regard to the connection device 100. For example, the connection member 12 can be fixed on the second support member 18 by clamping.

It is possible for the position of the connection member 12 with regard to the second support member 18 to be adjustable. This can be done, e.g., with a connection device 46 as described above with regard to the first support member 16.

The second support member 18 further comprises a spindle guiding device 104 with a threaded opening 106. This opening 106 is arranged parallel to the opening 102 in such a way that a threaded spindle 108 engaging into the thread of the threaded opening 106 can be moved back and forth in a direction parallel to the direction 14.

The threaded spindle 108 is positioned at a distance from the connection member 12.

At one end of the threaded spindle 108, a handle 110 is fixed via which rotation of the threaded spindle 108 (for effecting a linear movement parallel to the direction 14) can be actuated. The handle 110 has a finger member 112 which extends in a direction parallel to the direction 14 at a distance from the threaded spindle 108. The finger member 112 can be grasped for example by the thumb and index finger.

The second support member 18 is formed in such a way that the lower end of the handle 110 has a sufficient distance from the lower stand end 86 and thereby from the surface 21 on which the first support member 16 and the second support member 18 are positioned. This distance is mainly achieved by corresponding adaptation of the second stand portion 64 of the second support member 18. Thus, a clearance is provided and it is guaranteed that the hand of the operator will not touch the surface 21 when rotating the threaded spindle 108 via the handle 110.

Also, the varying width of the foot elements 72 allows more space for a user's hand when the threaded spindle 106 and therewith the handle 110 are close to an outer end 114 of the second support member 118. This outer end 114 faces away from the first support member 116.

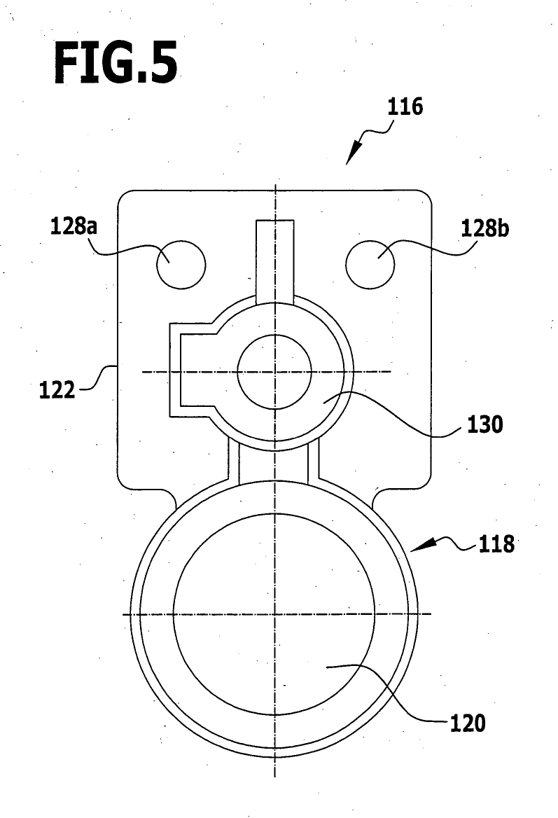

The threaded spindle 108 is fixed to a second clamping member 116 (FIG. 5). This second clamping member has a guiding portion 118 with an opening 120. Via the guiding portion 118, the second clamping member 116 is moveably positioned on the connection member 12. The connection member 12 is guided through the opening 120.

The second clamping member 116 further comprises a clamping area 122 with a clamping surface 124. The clamping surface 124 is arranged with regard to the clamping surface 40 in such a way that a workpiece or workpieces can be clamped between the clamping area 38 and the clamping area 122.

A plastic element 126, for example a plastic cap, can be arranged on the clamping area 120 in order to protect the workpiece (e.g., similar to plastic element 44).

Further, through-openings 128a, 128b can be provided for allowing the clamping area 122 to be fixed to a workpiece for example by screws.

The threaded spindle 108 is fixed to the second clamping member 116 at a height of the clamping area 122 in a manner which allows a relative rotation between the threaded spindle 108 and the clamping area 122 but no relative translational movement therebetween. Thus, any translational movement of the second clamping member 116 is actuated by the threaded spindle 108.

For fixing the threaded spindle 108 to the second clamping member 116, a recess 130 is provided in which an end portion 132 of the threaded spindle 108 is positioned. This end portion 132 is translationally fixed in the recess 130 but allows a rotational movement.

In accordance with an example embodiment of the present invention, foot elements 72 extend beyond the first surface 76 and the second surface 78 of the second stand portion 64. The first pair 80 and the second pair 82 of the foot elements 72 are at a distance from each other. Thus, two support planes defined by the stand surfaces 74 are provided which are at a distance from each other and which extend beyond the first surface 76 and the second surface 78. The provided stand surfaces have a main direction 134 (FIG. 3) which is perpendicular to the direction 94 and is substantially parallel to the direction 14. Thus, the tendency for tipping over of the clamping device 10 is reduced.

Further, mounting of the clamping device 10 or operating the clamping device 10 is made easier. An operator can hold the second support member 18 in an upright position during mounting of the clamping device 10 or during clamping of a workpiece or workpieces by putting pressure on the outer foot elements 86 and 90.

Further, the outer foot elements 86 and 90 can be provided with through-openings 96 which are easily accessible to fix the second support member 18 to the surface 21.

In the example embodiment shown in FIG. 1, the second surface 78 and the outer end 114 are substantially in the same plane.

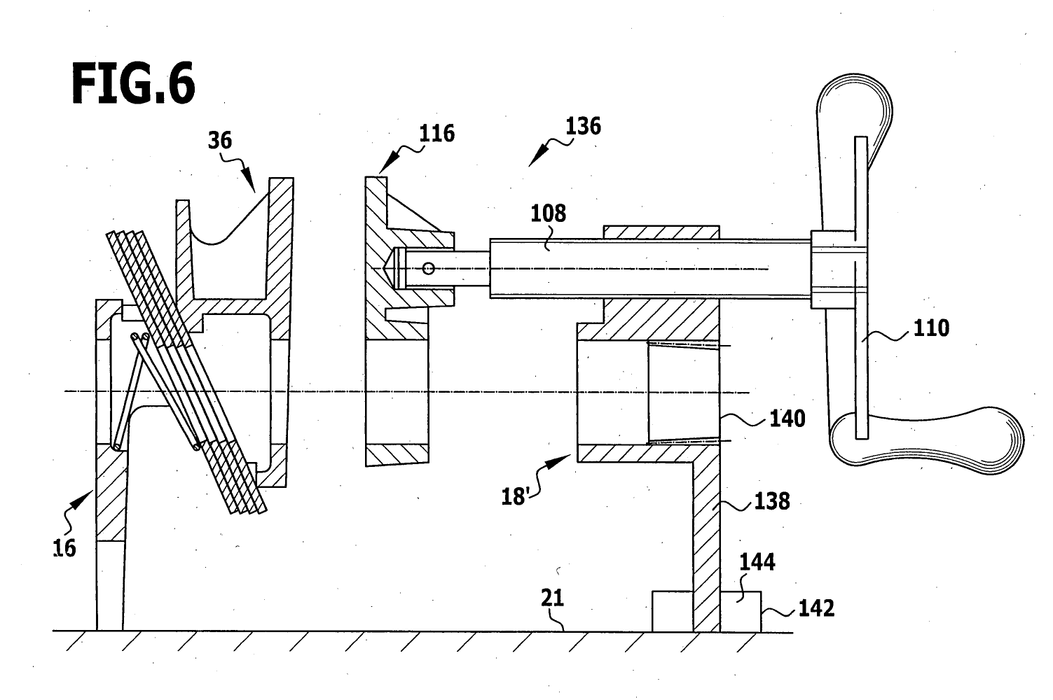

In a second example embodiment of a clamping device in accordance with the invention, which is shown in FIG. 6 and designated there as reference numeral 136, a second support member 18′ with a second stand portion 138 is provided. Said second stand portion 138 is set back with regard to an outer end 140 of the second support member 18′. The second stand portion 138 is set back in such a way that outer ends 142 of projecting foot elements 144 extending towards the outer end 140 do not project beyond the outer end 140. Thus, no elements of the second stand portion 138 can come between the handle 110 and the surface 21 in the space extending from the outer end 140 towards the handle 110.

In particular, it can be provided that the second stand portion 138 is arranged in such a way at the second support member 18′ that the center of mass of the second support member 18′ is above the second stand portion 138 (with regard to the direction of gravity). Thus, the second support member 18′ can be positioned standing on the surface 21.

The further elements of the clamping device 136 are the same as described above with regard to the clamping device 10.

It should now be appreciated that the present invention provides advantageous clamping device with improved stability and ease of operation.

Although the invention has been described in connection with various illustrated embodiments, numerous modifications and adaptations may be made thereto without departing from the spirit and scope of the invention as set forth in the claims.

What is claimed is:

1. Clamping device, comprising:
a first support member having a first stand portion for positioning the first support member on a surface;
a second support member having a second stand portion for positioning the second support member on the surface, the second stand portion having a first surface facing towards the first stand portion and having a second surface facing away from the first stand portion, the second stand portion comprising foot elements projecting from the first surface and projecting from the second surface;
a connection member fixed to the first support member and the second support member;
a first clamping member and a second clamping member for exerting a clamping force on a workpiece or workpieces between the first clamping member and the second clamping member, the first clamping member being arranged on the first support member and the second clamping member being moveable on the connection member;
a threaded spindle guidable on the second support member and connected to the second clamping member; and
a handle fixed to the threaded spindle.

2. Clamping device according to claim 1, wherein the foot elements are arranged up to an outer side edge of the second stand portion.

3. Clamping device according to claim 1, wherein a foot element projecting from one surface of the second stand portion has a counterpart foot element projecting from a second surface of the second stand portion.

4. Clamping device according to claim 3, wherein a stand surface defined by the foot element and the counterpart foot element has a maximum width in a direction parallel to the connection member which is larger than the width in a direction transverse to the connection member.

5. Clamping device according to claim 4, wherein the maximum width parallel to the connection member is at least 1.5 times larger than the maximum width transverse to the connection member.

6. Clamping device according to claim 3, wherein the foot element projecting from the one surface of the second stand portion and its counterpart foot element are symmetrical to each other.

7. Clamping device according to claim 1, wherein the foot elements comprise a first pair of foot elements and a second pair of foot elements.

8. Clamping device according to claim 7, wherein said first pair of foot elements and said second pair of foot elements are at a distance from each other.

9. Clamping device according to claim 8, wherein at least the foot elements projecting from the second surface have a varying width in a direction transverse to the connection member on portions facing each other with the width becoming smaller away from the second surface.

10. Clamping device according to claim 8, wherein the second stand portion has an opening between the first pair of foot elements and the second pair of foot elements, said opening extending towards a lower end face of the second stand portion.

11. Clamping device according to claim 10, wherein the opening has a height which is at least twice as large as the height of the foot elements.

12. Clamping device according to claim 10, wherein the opening has a width in a direction transverse to the connection member which is at most 45% of a maximum width of the second stand portion.

13. Clamping device according to claim 1, wherein a width of a foot element in a direction transverse to the connection member is at least 20% of a maximum width of the second stand portion.

14. Clamping device according to claim 1, wherein the foot elements have an extension width projecting from the first surface or the second surface in a direction parallel to the connection member which is larger than a distance between the first surface and the second surface.

15. Clamping device according to claim 1, wherein at least one of the foot elements has a through-opening towards its respective stand portion surface.

16. Clamping device according to claim 1, wherein the connection member is a pipe.

17. Clamping device according to claim 1, wherein at least one of the first clamping member and the second clamping member has a plastic element providing a contact surface for a workpiece.

18. Clamping device according to claim 1, wherein at least one of the first support member and second support member is adapted to be shiftable with regard to the connection member.

19. Clamping device according to claim 1, wherein:
the second stand portion is set back with regard to an outer end of the second support member, said outer end facing away from the first support member, and
said second stand portion does not project beyond said outer end.

20. Clamping device, comprising:
a first support member having a first stand portion for positioning the first support member on a surface;
a second support member having a second stand portion for positioning the second support member on the surface, the second stand portion being set back with regard to an outer end of the second support member, said outer end facing away from the first support member, and said second stand portion not projecting beyond said outer end;
a connection member fixed to the first support member and the second support member;
a first clamping member and a second clamping member for exerting a clamping force on a workpiece or workpieces between the first clamping member and the second clamping member, the first clamping member being arranged on the first support member and the second clamping member being moveable on the connection member;
a threaded spindle guidable on the second support member and connected to the second clamping member; and
a handle fixed to the threaded spindle.

21. Clamping device according to claim 20, wherein the connection member is a pipe.

22. Clamping device according to claim 20, wherein at least one of the first clamping member and second clamping member has a plastic element providing a contact surface for a workpiece.

23. Clamping device according to claim 20, wherein at least one of the first support member and second support member is adapted to be shiftable with regard to the connection member.
